(19) United States
(12) Patent Application Publication
(10) Pub. No.: US 2026/0360792 A1
(43) Pub. Date: Nov. 12, 2026

(54) ELECTRODE ASSEMBLY MANUFACTURING DEVICE AND ELECTRODE ASSEMBLY MANUFACTURING METHOD

(71) Applicant: SK On Co., Ltd., Seoul (KR)

(72) Inventors: Ju Hyeon LEE, Daejeon (KR); Seung Yeon KIM, Daejeon (KR); Chang Won LEE, Daejeon (KR)

(21) Appl. No.: 19/555,897

(22) Filed: Mar. 4, 2026

(30) Foreign Application Priority Data
Mar. 13, 2025 (KR) 10-2025-0032642

(51) Int. Cl. H01M 10/04

(52) U.S. Cl. CPC H01M 10/0404; H01M 10/0459; H01M 10/0468

(57) ABSTRACT

The present disclosure provides a device for manufacturing an electrode assembly including a first electrode, a second electrode, a first separator portion arranged between the first electrode and the second electrode, and a second separator portion extended from the first separator portion, including a separator-supplying unit unwinding and supplying a wound separator; a cutting unit cutting an extended separator supplied from the separator-supplying unit, to form a cutting separator including the first separator portion and the second separator portion; and a bonding unit attaching an end portion of the second separator portion to a stack in which the first electrode, the second electrode, and the first separator portion are arranged, wherein the bonding unit includes a nozzle unit applying an adhesive to one surface of the stack, and a sensor unit sensing a boundary of the one surface of the stack.

### CROSS-REFERENCE TO RELATED APPLICATION(S)

This patent document claims the priority and benefits of Korean Patent Application No. 10-2025-0032642 filed on Mar. 13, 2025, the disclosure of which is incorporated herein by reference in its entirety.

### TECHNICAL FIELD

The disclosure and implementations disclosed in this patent document generally relate to a device for manufacturing an electrode assembly, and a method for manufacturing the electrode assembly.

### BACKGROUND

Demand for secondary battery cells as an energy source is rapidly increasing, as technological development and demand for mobile devices, electric vehicles, energy storage devices, or the like increase. Secondary battery cells are batteries that may be repeatedly charged and discharged because mutual conversion between chemical and electrical energy is reversible.

A battery cell may include an electrode assembly including a positive electrode, a negative electrode, a separator, and the like, and an electrolyte. The battery cell may be provided as a pouch-type battery cell or a prismatic or cylindrical can-type battery cell.

A plurality of battery cells may be arranged in a predetermined pattern to constitute a battery module or a battery pack, and may be used for various purposes such as an electric vehicle, an energy storage system (ESS), or the like.

### SUMMARY

In a process of manufacturing an electrode assembly, a stack of a positive electrode, a negative electrode, and a separator may be wound by the separator, and the separator by which the stack is wound may be attached and finished by an adhesive. In this case, although a spraying position of an adhesive-spraying device is constant, there may be a problem that the spraying position of the adhesive is changed for each stack because there is a deviation in thickness for each stack.

According to an aspect of the present disclosure, a defect in finishing an electrode assembly due to an adhesive spraying position in a process of manufacturing the electrode assembly may be improved.

According to an aspect of the present disclosure, manpower for identifying an electrode assembly having a defect in finishing the same may be reduced.

A device for manufacturing an electrode assembly, and a method for manufacturing the electrode assembly, of the present disclosure, may be widely applied to devices within green technology fields such as electric vehicles, battery charging stations, and other solar power generation and wind power generation using batteries, or the like. In addition, a device for manufacturing an electrode assembly, and a method for manufacturing the electrode assembly, of the present disclosure, may be used in eco-friendly electric vehicles, hybrid vehicles, or the like, to ameliorate the effects of climate change by suppressing air pollution and greenhouse gas emissions.

In some embodiments of the present disclosure, a device for manufacturing an electrode assembly including a first electrode, a second electrode, a first separator portion arranged between the first electrode and the second electrode, and a second separator portion extended from the first separator portion, includes a separator-supplying unit unwinding and supplying a wound separator; a cutting unit cutting an extended separator supplied from the separator-supplying unit, to form a cutting separator including the first separator portion and the second separator portion; and a bonding unit attaching an end portion of the second separator portion to a stack in which the first electrode, the second electrode, and the first separator portion are arranged, wherein the bonding unit includes a nozzle unit applying an adhesive to one surface of the stack, and a sensor unit sensing a boundary of the one surface of the stack.

According to an embodiment, the sensor unit may sense the boundary of the one surface of the stack to derive a width and a length of the one surface of the stack.

According to an embodiment, the sensor unit may include at least one of a displacement sensor or a vision sensor.

According to an embodiment, a determination unit determining whether the adhesive is normally applied may be further included.

According to an embodiment, the determination unit may compare a calculated margin length to a measured margin length, to determine whether the adhesive is normally applied, and the margin length may be a distance in a length direction of the stack from a boundary of the adhesive to the boundary of the one surface of the stack.

According to an embodiment, the one surface of the stack may be a surface parallel to a stacking direction of the first electrode and the second electrode provided in the stack.

According to an embodiment, a gripping unit gripping the stack may be further included.

According to an embodiment, a holding unit structured to control tension of the second separator portion may be further included.

According to an embodiment, a pressing unit pressing the end portion of the second separator portion after the adhesive is applied may be further included.

According to an embodiment, a cutting tension unit providing tension to the extended separator may be further included.

A method for manufacturing an electrode assembly including a first electrode, a second electrode, a first separator portion arranged between the first electrode and the second electrode, and a second separator portion extended from the first separator portion, according to the present disclosure, includes a cutting operation of cutting an extended separator supplied from a separator-supplying unit to form a cutting separator including the first separator portion and the second separator portion; a winding operation of winding a stack in which the first separator portion is arranged between the first electrode and the second electrode toward the second separator portion; and a finishing operation of finishing an end portion of the second separator portion, wherein the finishing operation includes a sensation process of sensing a boundary of one surface of the stack; an application process of applying an adhesive to the one surface of the stack; and an attachment process of attaching the end portion of the second separator portion to the one surface of the stack.

According to an embodiment, the sensation process may sense the boundary of the one surface of the stack to derive a width and a length of the one surface of the stack.

According to an embodiment, the attachment process may press the end portion of the second separator portion, to attach the end portion of the second separator portion to the one surface of the stack.

According to an embodiment, the finishing operation may further include a determination process of determining whether the adhesive is normally applied, and the determination process may be performed between the application process and the attachment process.

According to an embodiment, the determination process may compare a calculated margin length with a measured margin length, to determine whether the adhesive is normally applied, and the margin length may be a distance in a length direction of the stack from a boundary of the adhesive to the boundary of the one surface of the stack.

According to an embodiment, the one surface of the stack may be a surface parallel to a stacking direction of the first electrode and the second electrode provided in the stack.

### BRIEF DESCRIPTION OF DRAWINGS

Certain aspects, features, and advantages of the present disclosure may be illustrated by the following detailed description with reference to the accompanying drawings.

FIGS. 1A to 1B illustrate a device for manufacturing an electrode assembly, according to an embodiment.

FIGS. 2A to 2D are schematic views illustrating processes of operating a gripping unit and a holding unit in a device for manufacturing an electrode assembly, according to an embodiment.

FIG. 3 is a perspective view illustrating a bonding unit and a determination unit in a device for manufacturing an electrode assembly, according to an embodiment.

FIGS. 4A to 4D are schematic views illustrating processes of operating a nozzle unit and a sensor unit in a device for manufacturing an electrode assembly, according to an embodiment.

FIG. 5 is a perspective view illustrating a process of operating a pressing unit in a device for manufacturing an electrode assembly, according to an embodiment.

FIGS. 6A to 6C are plan views illustrating electrode assemblies including a normally applied adhesive or an abnormally applied adhesive.

FIGS. 7A to 7C are cross-sectional views illustrating electrode assemblies including a normally applied adhesive or an abnormally applied adhesive.

FIG. 8 is a flowchart of a method for manufacturing an electrode assembly, according to an embodiment.

### DETAILED DESCRIPTION

The same reference numerals or reference numerals described in each drawing attached to the present specification denote components or components that perform substantially the same function. For convenience of description and understanding, the same reference numerals or reference numerals may be used in different embodiments. That is, even though components having the same reference number may be illustrated in a plurality of drawings, not all of the plurality of drawings mean an embodiment.

In the following description, singular expressions include plural expressions unless the context clearly indicates otherwise. Terms such as “comprise,” “include,” “constitute,” or the like may be intended to specify that features, numbers, steps, operations, elements, components, or combinations thereof described in the specification exist, and should be understood not to preclude the existence or addition of one or more other features, numbers, steps, operations, elements, components, or combinations thereof.

In addition, in the following description, expressions such as an upper side, an upper portion, on, a lower side, a lower portion, below, a side surface, a front surface, a rear surface, or the like may be expressed based on a direction illustrated in the drawings, and it may be revealed in advance that when a direction of an object is changed, it may be expressed differently.

In addition, terms including ordinal numbers such as “first,” “second,” or the like may be used in this specification and claim scope to distinguish between components. These ordinal numbers may be used to distinguish the same or similar components from each other, and the meaning of the term should not be limitedly interpreted due to the use of such ordinal numbers. For example, components combined with such ordinal numbers should not be interpreted in a limited order of use or arrangement by the numbers. As necessary, each ordinal may be used interchangeably.

Hereinafter, the present disclosure will be described in detail with reference to the accompanying drawings. However, this is illustrative only and the present disclosure may not be limited to the specific embodiments illustrated exemplarily.

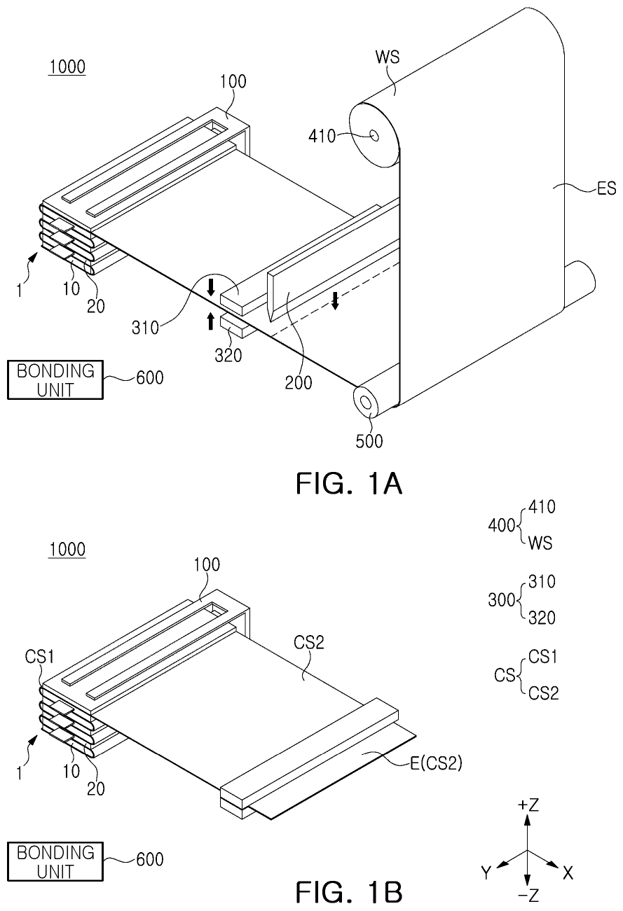

FIGS. 1A to 1B illustrate a device 1000 for manufacturing an electrode assembly according to an embodiment.

Referring to FIGS. 1A to 1B, a device 1000 for manufacturing an electrode assembly, according to an embodiment of the present disclosure, may include a separator-supplying unit 400 for unwinding and supplying a wound separator WS, a cutting unit 200 for cutting an extended separator ES supplied from the separator-supplying unit 400, to form a cutting separator CS including a first separator portion CS1 and a second separator portion CS2, and a bonding unit 600 for attaching an end portion E of the second separator portion CS2 to a stack 1 in which a first electrode 10, a second electrode 20, and the first separator portion CS1 are arranged. An electrode assembly 2 may include the first electrode 10, the second electrode 20, the first separator portion CS1 disposed between the first electrode 10 and the second electrode 20, and the second separator portion CS2 extending from the first separator portion CS1.

In the present disclosure, the stack 1 may refer to an aggregate of the first electrode 10, the first separator portion CS1, and the second electrode 20 in which arrangement is completed. Furthermore, an aggregate of the first electrode 10, the first separator portion CS1, the second separator portion CS2, and the second electrode 20, after the second separator portion CS2 is wound may also be referred to as the stack 1, before the end portion E of the second separator portion CS2 is finished. An aggregate of the first electrode 10, the first separator portion CS1, the second separator portion CS2, and the second electrode 20 may be referred to as the electrode assembly 2, after the end portion E of the second separator portion CS2 is finished.

The first electrode 10 may be provided on a stack table by a first electrode supply unit. The first electrode 10 may be a positive electrode or a negative electrode in some cases. The positive electrode may include a positive electrode current collector and a positive electrode mixture layer disposed on at least one surface of the positive electrode current collector. The negative electrode may include a negative electrode current collector and a negative electrode mixture layer disposed on at least one surface of the negative electrode current collector. The first electrode 10 may have a plate shape, and may be alternately arranged with the second electrode 20 with a separator interposed therebetween.

The second electrode 20 may be provided on the stack table by a second electrode supply unit. The second electrode 20 may be an electrode having polarity different from polarity of the first electrode 10. For example, when the first electrode 10 is a positive electrode, the second electrode 20 may be a negative electrode. The second electrode 20 may have a plate shape, and may be alternately arranged with the first electrode 10 with the separator interposed therebetween.

The separator-supplying unit 400 may include a core 410 and a wound separator WS wound around the core 410. The core 410 may have a hollow cylindrical shape, a solid cylindrical shape, or the like. The core 410 may include any material of various materials. For example, the core 410 may include a cardboard, a synthetic polymer (e.g., plastic), metal, wood, or any other material suitable for supporting the separator.

The separator may be configured to prevent an electrical short circuit between the positive electrode and the negative electrode and to generate a flow of ions. Depending on the embodiment, a thickness of the separator may be 10 μm to 20 μm, but is not limited thereto.

The separator may include a porous polymer film or a porous nonwoven fabric. The separator may have a single layer or multilayer structure including the polymer film and/or the nonwoven fabric.

The separator-supplying unit 400 may provide the separator wound around the core 410 to the stack table. In more detail, the separator-supplying unit 400 may provide the separator in a zigzag form. The first electrode 10 and the second electrode 20 may be alternately arranged with the separator interposed therebetween.

Before the separator is cut, the separator wound around the core 410 may be referred to as the wound separator WS, and the separator extending from the wound separator WS may be referred to as the extended separator ES. Therefore, before the separator is cut, the wound separator WS and the extended separator ES may be connected to each other.

When the extended separator ES is cut, the cutting separator CS may be formed. The cutting separator CS may include the first separator portion CS1 disposed between the first electrode 10 and the second electrode 20, and the second separator portion CS2 extending from the first separator portion CS1. The second separator portion CS2 may be provided to wind the stack 1.

According to an embodiment, a gripping unit 100 for gripping the stack 1 may be further included.

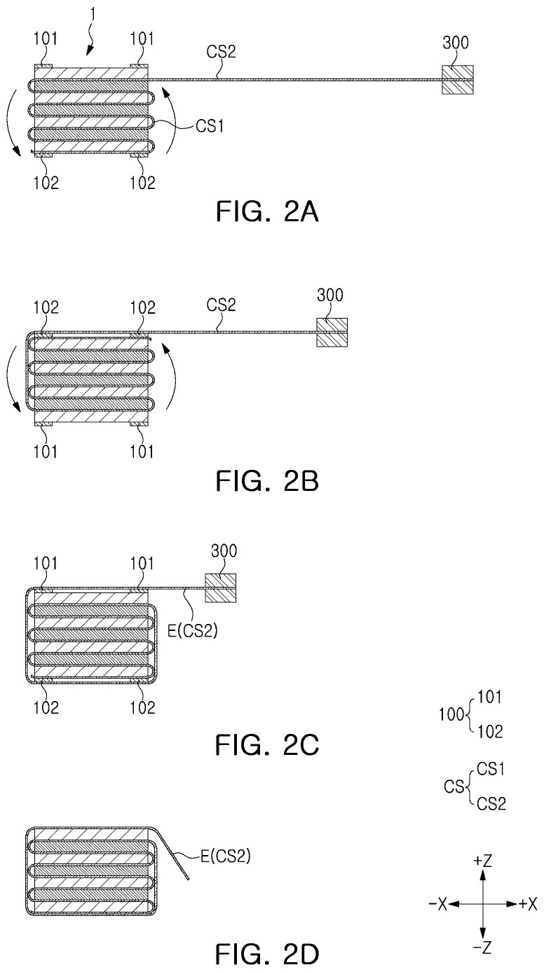

The gripping unit 100 may grip the stack 1. The gripping unit 100 may be provided as a gripper having a C shape. The gripping unit 100 may include an upper gripping unit 101 of FIG. 2A and a lower gripping unit 102 of FIG. 2A. The upper gripping unit (101 in FIG. 2A) may mean the gripping unit 100 disposed on a +Z side, and the lower gripping unit (102 in FIG. 2A) may mean the gripping unit 100 disposed on a −Z side.

The gripping unit 100 may grip the stack 1 by pressing upper and lower surfaces of the stack 1 in a Z-axis direction after the stack 1 is disposed between the upper gripping unit 101 of FIG. 2A and the lower gripping unit 102. More specifically, the upper gripping unit 101 of FIG. 2A may press the upper surface of the stack 1 in a −Z-direction. Also, the lower gripping unit 102 of FIG. 2A may press the lower surface of the stack 1 in a +Z-direction. The upper surface of the stack 1 may mean a surface located on the +Z side among outer surfaces of the stack 1 provided in the stack 1 or parallel to the second electrode 20. The lower surface of the stack 1 may mean a surface located on the −Z side of the outer surfaces of the stack 1 provided in the stack 1 or parallel to the second electrode 20.

At least one of the upper gripping unit 101 or the lower gripping unit 102 of FIG. 2A may be structured to move in the +Z-direction and the −Z-direction. Accordingly, the stack 1 may be gripped by pressing the upper and lower surfaces of the stack 1.

The cutting unit 200 may cut the extended separator ES to form the cutting separator CS. The cutting separator CS may include the first separator portion CS1 and the second separator portion CS2 extending from the first separator portion CS1 arranged between the first electrode 10 and the second electrode 20.

The cutting unit 200 may be structured to move in the +Z-direction and the −Z-direction. The cutting unit 200 may include a rotatable circular saw blade. A structure of the cutting unit 200 is not limited thereto, and as long as it is a structure capable of cutting the extended separator ES, it will be included in the cutting unit 200 of the present disclosure. For example, the cutting unit 200 may include a laser cutter.

According to an embodiment, a holding unit 300 structured to adjust tension of the second separator portion CS2 may be further included.

The holding unit 300 may fix the second separator portion CS2. The holding unit 300 may include an upper holding unit 310 and a lower holding unit 320. The upper holding unit 310 may mean the holding unit 300 disposed on the +Z side, and the lower holding unit 320 may mean the holding unit 300 disposed on the −Z side.

The holding unit 300 may fix the second separator portion CS2 by pressing upper and lower surfaces of the second separator portion CS2 in the Z-axis direction after the second separator portion CS2 is disposed between the upper holding unit 310 and the lower holding unit 320. More specifically, the upper holding unit 310 may press the upper surface of the second separator portion CS2 in the −Z-direction, and the lower holding unit 320 may press the lower surface of the second separator portion CS2 in the +Z-direction. Accordingly, the holding unit 300 may provide tension to the second separator portion CS2 in a process of winding the stack 1 to the second separator portion CS2.

In the drawings, the upper surface of the second separator portion CS2 may mean a surface located on the +Z side of the second separator portion CS2, and the lower surface of the second separator portion CS2 may mean a surface located on the −Z side of the second separator portion CS2.

The upper holding unit 310 may be structured to move in the −Z-direction, and the lower holding unit 320 may be structured to move in the +Z-direction. Therefore, the second separator portion CS2 may be fixed by pressing in the Z-axis direction from upper and lower portions.

According to an embodiment, a cutting tension unit 500 for providing tension to the extended separator ES may be further included. The cutting tension unit 500 may constantly provide tension to the extended separator ES before cutting. When the tension is not constantly provided to the separator, the separator may be folded, and accordingly, a problem of stacking failure may occur. In addition, when the tension is not constantly provided to the separator, and a physical external force such as cutting is applied to the separator, stress may be concentrated on a cut surface on a side of the separator-supplying unit 400, and thus the separator may be torn.

As illustrated, the cutting tension unit 500 may be provided as a roller or the like. A structure of the cutting tension unit 500 is not limited as long as it provides a constant tension to the extended separator ES, and may be included in the present disclosure.

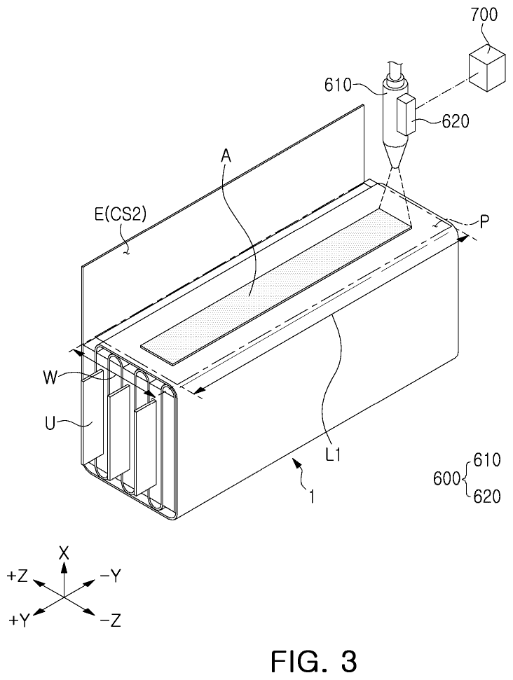

The bonding unit 600 may attach the end portion E of the second separator portion CS2 to the stack 1. A detailed configuration of the bonding unit 600 will be described later with reference to FIG. 3.

FIGS. 2A to 2D are schematic views illustrating processes of operating a gripping unit 100 and a holding unit 300 in a device 1000 for manufacturing an electrode assembly, according to an embodiment.

The stack 1, the cutting separator CS, the gripping unit 100, and the holding unit 300 of FIGS. 1A to 1B may also be applied to a stack 1, a cutting separator CS, a gripping unit 100, and a holding unit 300 of FIGS. 2A to 2D.

Referring to FIG. 2A, after an extended separator ES (see FIGS. 1A to 1B) is cut, a stack 1 may be gripped by a gripping unit 100, and a second separator portion CS2 may be fixed by a holding unit 300.

Referring to FIG. 2B, the gripping unit 100 may rotate for winding. As the gripping unit 100 rotates, the stack 1 gripped by the gripping unit 100 may also rotate. When the holding unit 300 is disposed on a +X side of the stack 1 in the drawing, a rotation direction of the gripping unit 100 may be a counterclockwise direction. The gripping unit 100 may rotate 180 degrees counterclockwise. Accordingly, an upper gripping unit 101 located on a +Z side in FIG. 2A may be located on a −Z side in FIG. 2B, and a lower gripping unit 102 located on the −Z side in FIG. 2A may be located on the +Z side in FIG. 2B.

The second separator portion CS2 may wind an outer surface of the stack 1 as the stack 1 rotates. In this case, the holding unit 300 may adjust tension provided to the second separator portion CS2 while moving toward the stack 1 during a winding process.

Referring to FIG. 2C, in a state of FIG. 2B, the gripping unit 100 may be further rotated counterclockwise by 180 degrees. Accordingly, the second separator portion CS2 may wind all outer surfaces of the stack 1. In addition, the upper gripping unit 101 located on the −Z side in FIG. 2B may be located on the +Z side in FIG. 2C, and the lower gripping unit 102 located on the +Z side in FIG. 2B may be located on the −Z side in FIG. 2C.

Referring to FIG. 2D, an end portion E of the second separator portion CS2 may refer to a remaining portion of the second separator portion CS2 that remains after being wound. For example, the end portion E of the second separator portion CS2 may refer to a separator to be finally subjected to a finishing treatment in the winding process.

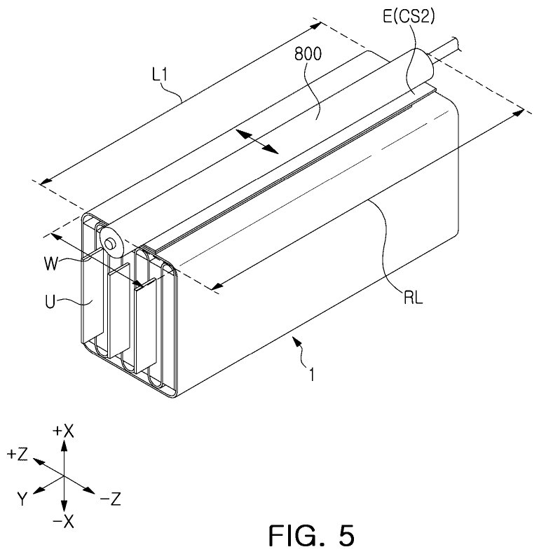

The end portion E of the second separator portion CS2 may be finished by a bonding unit 600 (see FIG. 3) and a pressing unit 800 (see FIG. 5), which will be described later.

FIG. 3 is a perspective view illustrating a bonding unit 600 and a determination unit 700 in a device 1000 for manufacturing an electrode assembly, according to an embodiment.

The stack 1 and the second separator portion CS2 in FIGS. 1A to 1B and 2A to 2D may also be applied to a stack 1 and a second separator portion CS2 in FIG. 3.

Referring to FIG. 3, a device 1000 for manufacturing an electrode assembly, according to an embodiment of the present disclosure, may include a bonding unit 600 attaching an end portion E of a second separator portion CS2 to one surface P of a stack. The bonding unit 600 may include a nozzle unit 610 applying an adhesive A to the one surface P of the stack and a sensor unit 620 sensing a boundary of the one surface P of the stack.

According to an embodiment, the one surface P of the stack may mean a surface parallel to a stacking direction Z of a first electrode 10 and a second electrode 20 provided in the stack 1. The one surface P of the stack may mean a surface parallel to the stacking direction Z of the first electrode 10 and the second electrode 20 provided in the stack 1 among outer surfaces of the stack 1. The stacking direction of the first electrode 10 and the second electrode 20 may correspond to a Z-axis direction. The one surface P of the stack may mean a surface parallel to an YZ plane among the outer surfaces of the stack 1.

According to an embodiment, the sensor unit 620 may sense the boundary of the one surface P of the stack to derive a width W and a length L1 of the one surface P of the stack.

The boundary between the one surface P of the stack may mean an edge of the one surface P of the stack. The width W of the one surface P of the stack may mean a length of the one surface P of the stack in the Z-axis direction. Also, the length L1 of the one surface P of the stack may mean a length of the one surface P of the stack in a Y-axis direction.

According to an embodiment, the sensor unit 620 may include at least one of a displacement sensor or a vision sensor.

The displacement sensor may sense the boundary of the one surface P of the stack by using at least one of an ultrasonic wave or a laser beam. Specifically, the displacement sensor may measure a difference in distance from the displacement sensor to a sensing target (e.g., the one surface P of the stack and an uncoated portion U of the electrode) by using at least one of the ultrasonic wave or the laser beam, and may sense the boundary of the one surface P of the stack.

The displacement sensor may sense a one side boundary of the one surface P of the stack and then move to a different side boundary of the one surface P of the stack, and may then sense the different side boundary of the one surface P of the stack. In this case, the displacement sensor may derive the width W or the length L1 of the one surface P of the stack from the moved distance.

For example, the displacement sensor may extend in the Z-axis direction among boundaries of the one surface P of the stack, may sense a boundary located on a +Y side, may move in a −Y direction, may extend in the Z-axis direction among the boundaries of the one surface P of the stack, and may sense a boundary located on a −Y side, to derive the length L1 of the one surface P of the stack. In this case, as an example, it has been described that the boundary located on the +Y side was sensed and then the boundary located on the −Y side was sensed, but a sequence of the sensed boundaries is not limited.

Similarly, the displacement sensor may extend in the Y-axis direction among the boundaries of the one surface P of the stack, may sense a boundary located on a −Z side, may move in a +Z-direction, may extend in the Y-axis direction among the boundaries of the one surface P of the stack, and may sense a boundary located on a +Z side, to derive the width W of the one surface P of the stack. In this case, as an example, it has been described that the boundary located on the −Z side was sensed and then the boundary located on the +Z side was sensed, but a sequence of the sensed boundaries is not limited.

The vision sensor may sense the boundary of the one surface P of the stack by using a difference in illuminance. Specifically, the vision sensor may capture an image of the one surface P of the stack, and may then sense the boundary of the one surface P of the stack based on the difference in illuminance.

The vision sensor and the displacement sensor may be the same in a process of deriving the width W or the length L1 of the stack after sensing the boundary of the one surface P of the stack. For example, the vision sensor may sense the one side boundary of the one surface P of the stack and then move to the different side boundary of the one surface P of the stack, and then sense the different side boundary of the one surface P of the stack. In this case, the vision sensor may derive the width W or the length L1 of the one surface P of the stack from the moved distance.

The nozzle unit 610 may apply an adhesive A to be normally bonded based on a value derived from the sensor unit 620. For example, the sensor unit 620 may provide a value of the width W of the one surface P of the stack to apply the adhesive A to the nozzle unit 610, thereby contributing to normal application of the adhesive A.

According to an embodiment, a determination unit 700 for determining whether the adhesive A is normally applied may be further included.

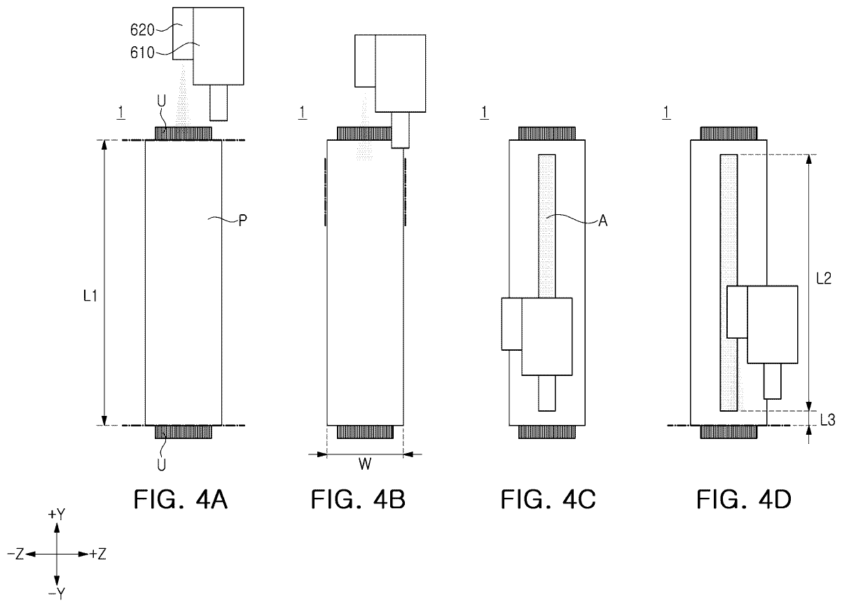

The determination unit 700 may receive the value derived from the sensor unit 620, and may determine whether the adhesive A is normally applied based on the value. Accordingly, manpower for determining whether the adhesive A is normally applied may be reduced. A detailed determination process of the determination unit 700 will be described later with reference to FIGS. 4A to 4D.

FIGS. 4A to 4D are schematic views illustrating processes of operating a nozzle unit 610 and a sensor unit 620 in a device 1000 for manufacturing an electrode assembly, according to an embodiment.

The stack 1 of FIGS. 1A to 1B and the bonding unit 600 of FIG. 3 may also be applied to a stack 1 and a bonding unit 600 of FIGS. 4A to 4D.

Referring to FIG. 4A, a sensor unit 620 may sense a boundary of one surface P of a stack while moving in an Y-axis direction, and may then derive a length L1 of the one surface P of the stack based thereon.

Referring to FIG. 4B, the sensor unit 620 may sense the boundary of the one surface P of the stack while moving in a Z-axis direction, and may then derive a width W of the one surface P of the stack based thereon.

Referring to FIG. 4C, based on values of the length L1 and the width W of the one surface P of the stack derived by the sensor unit 620, a nozzle unit 610 may move in the Y-axis direction, and may apply an adhesive A to the one surface P of the stack. For example, the sensor unit 620 may provide the values of the length L1 and the width W of the one surface P of the stack when the adhesive A is applied, thereby reducing defective bonding due to a deviation in thickness of the stack 1.

Referring to FIG. 4D, according to an embodiment, a determination unit 700 (see FIG. 3) may compare a calculated margin length L3 with a measured margin length L3 to determine whether the adhesive A is normally applied. The margin length L3 may mean a distance of the stack 1 in a length direction from a boundary of the adhesive A to the boundary of the one surface P of the stack.

The margin length L3 may be measured by the sensor unit 620. The margin length L3 measured by the sensor unit 620 may be transmitted to the determination unit 700 (see FIG. 3). The length L1 of the one surface P of the stack may be measured by the sensor unit 620. The measured length L1 of the one surface P of the stack may be transmitted to the determination unit 700 (see FIG. 3). An application length L2 of the adhesive A may be determined in advance. Accordingly, the margin length L3 of the one surface P of the stack may be calculated from the length L1 of the one surface P of the stack and the application length L2 of the adhesive A. The margin length L3 of the one surface P of the stack may be calculated by L3=(L1−L2)/2.

The determination unit 700 (see FIG. 3) may determine that the adhesive A is normally applied, when the measured margin length L3 is equal to the calculated margin length L3, and may determine that the adhesive A is abnormally applied, when the measured margin length L3 is different from the calculated margin length L3. Accordingly, the determination unit 700 (see FIG. 3) may reduce manpower required for determining whether the adhesive A is normally applied.

FIG. 5 is a perspective view illustrating a process of operating a pressing unit 800 in a device 1000 for manufacturing an electrode assembly, according to an embodiment.

The stack 1 of FIGS. 1A to 1B may be equally applied to a stack 1 of FIG. 5.

Referring to FIGS. 4A to 4D and 5, a device 1000 for manufacturing an electrode assembly may further include a pressing unit 800 pressing an end portion E of a second separator portion CS2 after an adhesive A is applied.

The pressing unit 800 may press the end portion E of the second separator portion CS2 to attach the end portion E of the second separator portion CS2 to one surface P of a stack. In the drawings, the pressing unit 800 in a roller form may press and adhere the end portion E of the second separator portion CS2 to the one surface P of the stack, but the pressing unit 800 is not limited to a roller structure. For example, the pressing unit 800 may be structured in a brush form or in a form of using pneumatic pressure of a blow. Hereinafter, it will be described that the pressing unit 800 has a form of a roller as an example.

The pressing unit 800 may press the end portion E of the stack to the one surface P of the stack while being in close contact with the one surface P of the stack and rotating, to attach the end portion E of the second separator portion CS2. The pressing unit 800 may have a shape extending in a Y-axis direction. The pressing unit 800 may press the end portion E of the stack to the one surface P of the stack while moving in a Z-axis direction, to attach the end portion E of the second separator portion CS2. A moving section of the pressing unit 800 to a width W of the one surface P of the stack may be set to reduce the moving section of the pressing unit 800, to improve work efficiency.

The pressing unit 800 may be formed such that a length RL of the pressing unit 800 is greater than a length L1 of the one surface P of the stack. Therefore, it is possible to reduce a phenomenon in which the end portion E of the second separator portion CS2 is pushed during an attachment operation. The length RL of the pressing unit 800 may mean a length in the Y-axis direction.

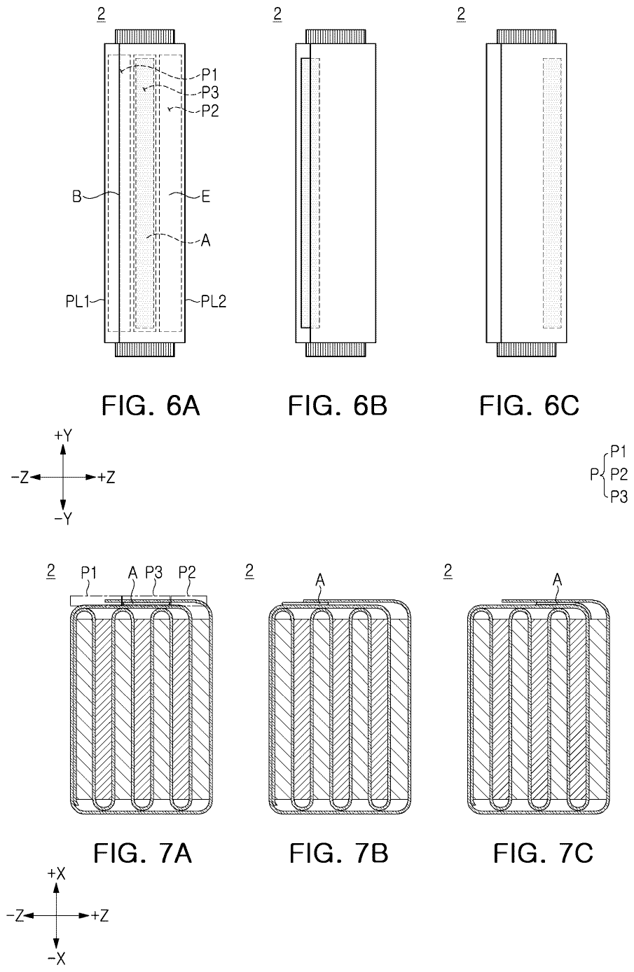

FIGS. 6A to 6C are plan views illustrating electrode assemblies 2 including a normally applied adhesive A or an abnormally applied adhesive A. FIGS. 7A to 7C are cross-sectional views illustrating electrode assemblies 2 including a normally applied adhesive A or an abnormally applied adhesive A.

FIG. 6A, and FIG. 7A illustrate a state in which an adhesive A is normally applied to one surface P of a stack. A state in which the adhesive A is normally applied may be referred to as normal bonding.

FIG. 6B, and FIG. 7B illustrate a state in which the adhesive A is abnormally applied to the one surface P of the stack. Thereamong, a case in which non-bonding occurs is illustrated.

FIG. 6C, and FIG. 7C illustrate a state in which the adhesive A is abnormally applied to the one surface P of the stack. Thereamong, a case in which excessive bonding occurs is illustrated.

The one surface P of the stack may include a first edge PL1 and a second edge PL2. The first edge PL1 and the second edge PL2 may extend in the Y-axis direction. The first edge PL1 may refer to an edge adjacent to a boundary B of an end portion E of a second separator portion CS2, and the second edge PL2 may refer to an edge facing the first edge PL1.

The one surface P of the stack may include a first region P1 adjacent to the boundary B of the end portion E of the second separator portion CS2, a second region P2 adjacent to the second edge PL2, and a third region P3 located between the first region P1 and the second region P2.

Referring to FIG. 6A, and FIG. 7A, the normal bonding may mean that the adhesive A is in entire contact with the end portion E of the second separator portion CS2, and is not be in contact with an electrode. When the adhesive A is applied to the third region P3, the adhesive A may be normally bonded.

Referring to FIG. 6B, and FIG. 7B, the non-bonding may mean that at least a portion of the adhesive A is not in contact with the end portion E of the second separator portion CS2. When the adhesive A is applied to the first region P1, at least a portion of the adhesive A may not be in contact with the end portion E of the second separator portion CS2. Therefore, when the adhesive A is applied to the first region P1, the adhesive A may not be bonded.

Referring to FIG. 6C, and FIG. 7C, the excessive bonding may mean that at least a portion of the adhesive A flows down and comes into contact with the electrode. When the adhesive A is applied to the second region P2, at least a portion of the adhesive A may flow down and come into contact with the electrode. Accordingly, when the adhesive A is applied to the second region P2, the adhesive A may be excessively bonded.

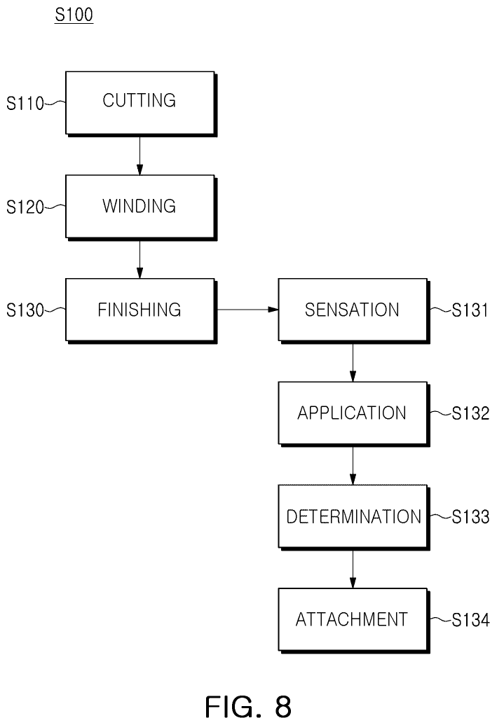

FIG. 8 is a flowchart of a method (S100) for manufacturing an electrode assembly, according to an embodiment.

Referring to FIG. 8 together with FIGS. 1A to 7C, a method (S100) for manufacturing an electrode assembly, according to an embodiment of the present disclosure, may include a cutting operation (S110) of cutting an extended separator ES supplied from a separator-supplying unit 400 to form a cutting separator CS including a first separator portion CS1 and a second separator portion CS2. An electrode assembly 2 may include a first electrode 10, a second electrode 20, the first separator portion CS1 disposed between the first electrode 10 and the second electrode 20, and the second separator portion CS2 extending from the first separator portion CS1.

The cutting operation (S110) may be performed by a cutting unit 200. A gripping unit 100 may grip a stack 1, and the cutting unit 200 may cut the extended separator ES. In this case, for smooth cutting, a cutting tension unit 500 may provide tension to the extended separator ES.

The second separator portion CS2 formed by cutting the extended separator ES may be fixed by a holding unit 300.

A method (S100) for manufacturing an electrode assembly, according to an embodiment of the present disclosure, may include a winding operation (S120) of winding the stack 1 in which the first separator portion CS1 is arranged between the first electrode 10 and the second electrode 20 toward the second separator portion CS2.

After the cutting operation (S110), the stack 1 may be gripped by the gripping unit 100, and the second separator portion CS2 may be fixed by the holding unit 300. The gripping unit 100 may rotate for winding. As the gripping unit 100 rotates, the stack 1 held by the gripping unit 100 may also rotate. The second separator portion CS2 may wind an outer surface of the stack 1 as the stack 1 rotates. The holding unit 300 may adjust tension provided to the second separator portion CS2 during a winding process.

A method (S100) for manufacturing an electrode assembly, according to an embodiment of the present disclosure, may include a finishing operation (S130) of finishing an end portion E of the second separator portion CS2. The finishing operation (S130) may include a sensation process (S131) of sensing a boundary of one surface P of the stack and an application process (S132) of applying an adhesive A to the one surface P of the stack.

According to an embodiment, the sensation process (S131) may sense the boundary of the one surface P of the stack to derive a width W and a length L1 of the one surface P of the stack.

The sensation process (S131) may be performed by a sensor unit 620. The sensor unit 620 may move in a Y-axis direction to derive a value of the length L1 of the one surface P of the stack. Thereafter, the sensor unit 620 may move in a Z-axis direction to derive a value of the width W of the one surface P of the stack. After determining a third region P3 corresponding to normal bonding in the stack 1 based on the value derived from the sensor unit 620, a nozzle unit 610 may apply the adhesive A to the third region P3.

According to an embodiment, the finishing operation (S130) may further include a determination process (S133) of determining whether the adhesive A is normally applied. The determination process (S133) may be performed between the application process (S132) and an attachment process (S134).

In an embodiment, the determination process (S133) after the adhesive A is applied by the nozzle unit 610 may determine whether the adhesive A is normally applied based on a calculated margin length L3 and a measured margin length L3. In this case, the margin length L3 may mean a distance of the stack 1 in a length direction from a boundary of the adhesive A to the boundary of the one surface P of the stack. The length direction of the stack 1 may be a Y-direction.

The determination process (S133) may be performed by a determination unit 700. The sensor unit 620 may measure the margin length L3 after the adhesive A is applied, and may transmit the measured margin length to the determination unit 700. The determination unit 700 may calculate the margin length L3 based on the length L1 of the one surface P of the stack measured by the sensor unit 620 and a length L2 of the adhesive A previously inputted. Consequently, the determination unit 700 may compare the measured margin length L3 with the calculated margin length L3 to determine whether the adhesive A is normally applied.

The finishing operation (S130) may include an attachment process (S134) of attaching the end portion E of the second separator portion CS2 to the one surface P of the stack.

For example, according to an embodiment, in the attachment process (S134), the end portion E of the second separator portion CS2 may be attached to the one surface P of the stack by pressing the end portion E of the second separator portion CS2.

According to an embodiment, the one surface P of the stack may mean a surface parallel to a stacking direction Z of the first electrode 10 and the second electrode 20 provided in the stack 1.

The attachment process (S134) may be performed by a pressing unit 800. The pressing unit 800 may press the end portion E of the second separator portion CS2 in a −X direction to attach the same to the one surface P of the stack.

According to an embodiment, a defect in finishing an electrode assembly due to an adhesive spraying position in a process of manufacturing the electrode assembly may be improved.

According to an embodiment, manpower for identifying an electrode assembly having a defect in finishing the same may be reduced.

Only specific examples of implementations of certain embodiments may be described. Variations, improvements and enhancements of the disclosed embodiments and other embodiments may be made based on the disclosure of this patent document.

What is claimed is:

1. A device for manufacturing an electrode assembly including a first electrode, a second electrode, a first separator portion arranged between the first electrode and the second electrode, and a second separator portion extended from the first separator portion, comprising:
a separator-supplying unit unwinding and supplying a wound separator;
a cutting unit cutting an extended separator supplied from the separator-supplying unit, to form a cutting separator including the first separator portion and the second separator portion; and
a bonding unit attaching an end portion of the second separator portion to a stack in which the first electrode, the second electrode, and the first separator portion are arranged,
wherein the bonding unit includes a nozzle unit applying an adhesive to one surface of the stack, and a sensor unit sensing a boundary of the one surface of the stack.

2. The device of claim 1, wherein the sensor unit senses the boundary of the one surface of the stack to derive a width and a length of the one surface of the stack.

3. The device of claim 1, wherein the sensor unit includes at least one of a displacement sensor or a vision sensor.

4. The device of claim 1, further including a determination unit determining whether the adhesive is normally applied.

5. The device of claim 4, wherein the determination unit compares a calculated margin length with a measured margin length, to determine whether the adhesive is normally applied, and
the margin length is a distance in a length direction of the stack from a boundary of the adhesive to the boundary of the one surface of the stack.

6. The device of claim 1, wherein the one surface of the stack is a surface parallel to a stacking direction of the first electrode and the second electrode provided in the stack.

7. The device of claim 1, further including a gripping unit gripping the stack.

8. The device of claim 1, further including a holding unit structured to control tension of the second separator portion.

9. The device of claim 1, further including a pressing unit pressing the end portion of the second separator portion after the adhesive is applied.

10. The device of claim 1, further including a cutting tension unit providing tension to the extended separator.

11. A method for manufacturing an electrode assembly including a first electrode, a second electrode, a first separator portion arranged between the first electrode and the second electrode, and a second separator portion extended from the first separator portion, comprising:
a cutting operation of cutting an extended separator supplied from a separator-supplying unit to form a cutting separator including the first separator portion and the second separator portion;
a winding operation of winding a stack in which the first separator portion is arranged between the first electrode and the second electrode toward the second separator portion; and
a finishing operation of finishing an end portion of the second separator portion,
wherein the finishing operation includes:
a sensation process of sensing a boundary of one surface of the stack;
an application process of applying an adhesive to the one surface of the stack; and
an attachment process of attaching the end portion of the second separator portion to the one surface of the stack.

12. The method of claim 11, wherein the sensation process senses the boundary of the one surface of the stack to derive a width and a length of the one surface of the stack.

13. The method of claim 11, wherein the attachment process presses the end portion of the second separator portion, to attach the end portion of the second separator portion to the one surface of the stack.

14. The method of claim 11, wherein the finishing operation further includes a determination process of determining whether the adhesive is normally applied, and
wherein the determination process is performed between the application process and the attachment process.

15. The method of claim 14, wherein the determination process compares a calculated margin length with a measured margin length, to determine whether the adhesive is normally applied, and
the margin length is a distance in a length direction of the stack from a boundary of the adhesive to the boundary of the one surface of the stack.

16. The method of claim 11, wherein the one surface of the stack is a surface parallel to a stacking direction of the first electrode and the second electrode provided in the stack.
